(19) United States
(12) Patent Application Publication
(10) Pub. No.: US 2008/0069354 A1
(43) Pub. Date: Mar. 20, 2008

(54) Information Processing Device, Information Processing Method, and Computer Program

(75) Inventors: Satoshi Kitani, Tokyo (JP); Katsumi Muramatsu, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/571,675

(22) PCT Filed: Jul. 7, 2005
(86) PCT No.: PCT/JP05/12552

§ 371 Date: Jan. 5, 2007

(30) Foreign Application Priority Data
Jul. 15, 2004 (JP) 2004-209116

(51) Int. Cl. H04N 7/167; H04L 9/00

(52) U.S. Cl. 380/202; 380/44

(57) ABSTRACT

A configuration for preventing information leakage in content use involving data transfer between different devices and illegal content processing is provided. In a content reproduction or recording process involving data transfer between different devices, such as a drive and a host, a media ID (disc ID) used for a content encryption or decryption process is read from a medium. The drive verifies whether the media ID has been recorded in such a manner as to correspond to a header code set on a correct valid medium. When the medium is confirmed to be a valid medium by the verification, on the drive side, the media ID is encrypted and output to the host. With this configuration outside leakage of the media ID, and a content reproduction or recording process using an invalid medium can be prevented.

### TECHNICAL FIELD

The present invention relates to an information processing apparatus, an information processing method, and a computer program. More particularly, the present invention relates to an information processing apparatus having a configuration for preventing unauthorized use of content, to an information processing method for use therewith, and to a computer program for use therewith.

### BACKGROUND ART

In recent years, information recording media capable of storing a large amount of data, such as DVDs or blue-laser discs (Blu-ray Discs), have become popular. For example, digital content, such as high-precision image data or high-quality audio data, recorded onto or reproduced from recording media such as discs, has come into general use.

According to a digital recording apparatus and a recording medium, images and audio can be repeatedly recorded and reproduced without degrading hem. Therefore, the distribution of illegally copied content via the Internet, and the distribution of pirated discs produced using a recording medium such as a CD-R and a DVD, onto which content has been recorded, have become big problems.

For performing processing for reproducing and recording content from and onto an information recording medium, there are two types of processing: one type of processing that uses an apparatus in which a drive for driving an information recording medium (disc) and reproduction/recording processing functions are integrated, and another type of processing in which a drive and an information processing apparatus, such as a PC, serving as a host for executing a reproduction processing pro-ram or a recording processing program are connected to each other via a bus or the like, this type of processing involving data transfer between the drive and the host.

When data is to be transferred between a drive and a hosts for example, there are problems in that leakage of contents key information and other secret information is likely to occurs and as a results the possibility of unauthorized use and leakage of content becomes high in general, sales rights or the like of most contents such as music data and image data, are held by the creator thereof or the seller thereof. Therefore, when distributing these pieces of content, it is common practice that a fixed use limitation is imposed, that is, use of content is permitted for an authorized user so that copying without permission or the like will not be performed.

It is possible to store video information and music information as digital data in large-capacity recording media, such as DVDs and blue-laser discs. When such digital data recording media are to be distributed in the market, a configuration for preventing unauthorized copying and for protecting a copyright owner becomes indispensable. In recent years, in order to prevent such unauthorized copying of digital data, various technologies for preventing illegal copying to digital recording apparatuses and recording media have been implemented.

For example, a content scramble system (CSS) and content protection for recordable media (CPRM) or the like are known. CPRM has a configuration in which even when an encryption key is leaked a process for selectively revoking a key is made possible, and thus has a strong copyright protection function.

In CPRM, an apparatus for reproducing encrypted content from an information recording medium or for recording encrypted content onto an information recording medium obtains an encrypted key block (for examples a media key block (MKB) and a renewal key block (RKB)) recorded on a recording medium obtains a media key by decrypting an encrypted key block by using a device key stored in the apparatus, obtains a key used to decrypt or encrypt content by performing an encryption process on the basis of the obtained media key and a recording-medium-specific media ID that can be read from the recording medium, and a plurality of data processes including an encryption process in accordance with a sequence defined by CPRM, and performs a content decryption and reproduction process or a content encryption and recording process by using the obtained key.

In general, the media ID is set as data that only a specific licensed media manufacturer can record and is recorded on a medium as data that can be read only by a data recording/reproduction program in accordance with CPRM processing. More specifically, the media ID is recorded in a burst cutting area (BCA) set in the inner peripheral region of the information recording medium by a method differing from a normal data recording method.

MKBs and RKBs serving as encrypted key blocks are encrypted key block data managed by a specific management center, such as a key management center, are provided to a specific licensed medium manufacturer, and are updated as appropriate. When updating an MKB and an RKB, updating is performed to form a key block in which individual device keys distributed to a device (a reproduction device, a PC) that is determined to be unauthorized are selectively revoked, and obtaining a media key using the revoked device key is not possible. With this configuration, it is possible to eliminate content use in an unauthorized device.

When content is to be reproduced or recorded on the basis of CPRM, the information processing apparatus performs processing in accordance with a given processing sequence defined by CPRM in the manner described above. In CPRM, the content copying permission type is determined in accordance with copy control information (CCI), and an information processing apparatus for reproducing and recording content is regulated so as to perform processing in accordance with CCI. The following settings are available for CCI: “copy no more” in which copying is not permitted, “copy once” in which only one copying is permitted, “copy free” in which copying is permitted, etc. An apparatus for reproducing, copying, and recording content in accordance with CPRM executes a reproduction or recording program in compliance with CPRM, and performs processing, such as reading, updating or the like of CCI as processes contained in the program.

However, even when such a CPRM method is used, there are cases in which a possibility of unauthorized use of content cannot be eliminated. For example, in a device that has not received a valid license in the scenario described below, there is a possibility that a content recording medium in compliance with CPRM can be user-created.

a) Authorized CPRM recording software, that is, a program in compliance with CPRM, used for recording encrypted content on a medium is analyzed, and the CPRM processing sequence is understood. All secrets regarding content encryption are processed by the CPRM recording software, and as a result, if analyzed, the entire organization of the software is made public.

b) By using the analyzed CPRM recording software, media keys that are secretly recorded in media key blocks (MKBs) of many CPRM recording discs can be extracted. Furthermore, a media ID recorded on a BCA is read, and the correspondences between media IDs and media keys obtained from the MKB are formed as a database. This analysis can be performed until the device key of the device having the CPRM recording software is revoked.

c) By using the analyzed authorized CPRM recording software, CPRM recording software can be user-created without receiving a license. The user-created software allows a media ID recorded in the BCA of a CPRM recording disc (data writable disc in compliance with CPRM) to be read, allows the read media ID to be transmitted to a management server for holding the correspondences between media IDs and media keys as a database, and allows a media key corresponding to the media ID to be transmitted from the server.

d) By using the user-created CPRM recording software, by using the media key obtained from the server, and by using an illegally obtained media key for a CPRM-compliant medium, encrypted content is created in accordance with a data encryption and recording sequence in compliance with CPRM, and is recorded on a medium.

As a result of the processing, by using the media key obtained from the server, it is possible to record encrypted content on a medium such as a CPRM-compliant DVD without performing a process in accordance with an authorized CPRM sequence, that is, an MKB process using a device key. As a result, for content that is encrypted and recorded, compatibility with a product manufactured under a valid license can be maintained.

As a result, with user-created CPRM recording software that has not received a valid license being distributed, there is a possibility that a rule that should be obeyed is not obeyed, for example, copy control information (CCI) is illegally rewritten, and content that is permitted to be copied only once (copy once) is illegally changed to copy-free content, such content being recorded on a medium together with an illegal content recording medium. A problem can also occur in that legally recorded encrypted content is read and converted into plain text, and is copied by user-created software.

### DISCLOSURE OF INVENTION

### Problems to be solved by the Invention

The present invention has been made in view of the above-described problems. It is an object of the present invention to provide an information processing apparatus for realizing elimination of unauthorized use of copyrighted content, an information processing method for use therewith, and a computer program for use therewith. More specifically, it is an object of the present invention to provide a configuration for preventing outside leakage of a media ID recorded in such a manner as to correspond to a medium (information recording medium) such as a DVD, for example, provide an information processing apparatus having a configuration for preventing illegal obtaining of a media ID by using an unauthorized CPRM software program, an information processing method for use therewith, and a computer program for use therewith.

### Means for Solving the Problems

A first aspect of the present invention relates to an information processing apparatus including:

a recording medium interface for performing input and output of data to be written onto an information recording medium or data to be read from an information recording medium;

a data transferring interface for performing input and output of transfer data from and to an external device;

a storage section in which verification data for confirming the validity of the information recording medium is stored; and

a data processor for reading code recorded on the information recording medium as information corresponding to a media identifier of the information recording medium, for confirming the validity of the information recording medium by verifying the code against the verification data, and for encrypting and externally outputting the media identifier under the condition that the validity has been confirmed.

In an embodiment of the information processing apparatus of the present invention, the data processor performs an authentication process for the external device that inputs and outputs data via the data transferring interface and outputs the media identifier to the external device under the condition that the result of the authentication process is positive.

In an embodiment of the information processing apparatus of the present invention, the data processor encrypts the media identifier by using a session key generated in the authentication process and outputs the media identifier as encrypted data on the basis of the session key to the external device.

In an embodiment of the information processing apparatus of the present invention, the storage section stores code information set in such a manner as to correspond to the identifier of the information recording medium that is legally manufactured under a license and the data processor reads code recorded on the information recording medium as information corresponding to the media identifier of the information recording medium, confirms the validity of the information recording medium by verifying the code against the code stored as the verification data, and encrypts and externally outputs the media identifier under the condition that the validity has been confirmed.

In an embodiment of the information processing apparatus of the present invention, the data processor reads code as information corresponding to the media identifier recorded in a BCA (burst cutting area) of the information recording medium and verifies the code against the verification data.

In an embodiment of the information processing apparatus of the present invention, the data processor inputs encrypted data on the basis of an encryption key generated by using the media identifier from the external device via the data transferring interface, and writes the input data onto an information recording medium.

In an embodiment of the information processing apparatus of the present invention, the data processor reads, from the information recording medium, encrypted data on the basis of an encryption key generated by using the media identifier, and outputs the read data to the external device via the data transferring interface.

A second aspect of the present invention relates to an information processing method including:

a code reading step of reading code recorded on an information recording medium as information corresponding to a media identifier of the information recording medium;

a validity confirmation step of confirming the validity of the information recording medium by verifying the code against verification data stored in a storage section; and

a media identifier output step of encrypting and externally outputting the media identifier under the condition that the validity of the information recording medium has been confirmed in the validity confirmation step.

In an embodiment of the information processing method of the present invention, the information processing method further includes an authentication performing step of performing an authentication process with an external device that inputs and outputs data via the data transferring interface wherein a process for outputting the media identifier to the external device is performed under the condition that the result of the authentication process is positive.

In an embodiment of the information processing method of the present invention, the media identifier output step is a step of encrypting the media identifier by using a session key generated in the authentication process and outputting the media identifier as encrypted data on the basis of the session key to the external device.

In an embodiment of the information processing method of the present invention, the validity confirmation step is a step of reading code recorded on the information recording medium as information corresponding to a media identifier of the information recording medium and confirming the validity of the information recording medium by verifying the code against code that is set in such a manner as to correspond to an identifier of the information recording medium that is legally manufactured under a license stored in a storage section.

In an embodiment of the information processing method of the present invention, the code reading step is a step of reading code as information corresponding to the media identifier recorded in a BCA (burst cutting area) of the information recording medium.

In an embodiment of the information processing method of the present invention, the information processing method further includes a step of inputting encrypted data on the basis of an encryption key generated by using the media identifier from an external device via the data transferring interface; and a step of writing the input data onto the information recording medium.

In an embodiment of the information processing method of the present invention, the information processing method further includes a step of reading, from the information recording medium the encrypted data on the basis of an encryption key generated by using the media identifier; and a step of outputting the read data to the external device via the data transferring interface.

A third aspect of the present invention relates to a computer program that performs access control for an information recording medium the computer program including:

a code reading step of reading code recorded on an information recording medium as information corresponding to a media identifier of the information recording medium;

a validity confirmation step of confirming the validity of the information recording medium by verifying the code against verification data stored in a storage section; and

a media identifier output step of encrypting and externally outputting the media identifier under the condition that the validity of the information recording medium has been confirmed in the validity confirmation step.

The computer program according to the present invention is, for example, a computer program that can be provided by a recording medium and a communication medium for providing various program codes in a computer-readable format to a computer system capable of executing them, for example, a recording medium such as a CD, an FD, and an MO, or a communication medium such as a network. Since such a program is provided in a computer-readable format, processing corresponding to the program is realized in the computer system.

Further other objects, features, and advantages of the present invention will become apparent from the detailed description based on the embodiments of the present invention as will be described later and the attached drawings. In this specification, the system designates a logical assembly of a plurality of devices. It is not essential that the devices be disposed in the same housing.

### ADVANTAGES

According to the configuration of the present invention, in a content reproduction or recording process involving data transfer between two different devices, such as a drive and a host, it is possible to prevent outside leakage of a media ID (disc ID) used for a content encryption or recording process performed when content is to be recorded or reproduced.

According to the configuration of the present invention the drive reads a media ID (disc ID) from a medium. Whether this media ID has been recorded in such a manner as to correspond to a header code set for a valid medium is verified on the drive side. Furthermore, when it is confirmed by the verification that the medium is a valid medium, since the media ID is encrypted on the drive side and is output to the host, the possibility of outside leakage of the media ID can be decreased. Furthermore since a content reproduction or recording process is permitted under the condition that the medium is confirmed to be a valid medium, a content reproduction or recording process using an invalid medium can be prevented.

### BRIEF DESCRIPTION OF THE DRAWINGS

FIG. 1 illustrates a content recording/reproduction process sequence in compliance with CPRM.

FIG. 2 illustrates a content recording/reproduction process sequence in compliance with CPRM.

FIG. 3 is a flowchart illustrating a process control sequence based on MAC verification in the content recording/reproduction process in compliance with CPRM.

FIG. 4 illustrates the data structure of a BCA area.

FIG. 5 illustrates the data format of a media ID (disc ID) recorded in the BCA area.

FIG. 6 illustrates a content recording/reproduction process involving content transfer between a host and a drive according to the present invention.

FIG. 7 illustrates a mutual authentication and key exchanging sequence between the host and the drive.

FIG. 8 illustrates the data structure of a public key certificate.

FIG. 9 is a flowchart illustrating a processing sequence for transferring and verifying a media ID (disc ID) recorded in a BCA area.

FIG. 10 is a flowchart illustrating a sequence of processing for transferring and verifying outputable data other than the media ID (disc ID) recorded in the BCA area.

FIG. 11 is a flowchart illustrating a processing sequence on the drive side in the content recording/reproduction process involving content transfer between the host and the drive.

FIG. 12 is a flowchart illustrating a processing sequence on the drive side in the content recording/reproduction process involving content transfer between the host and the drive.

FIG. 13 is a flowchart illustrating a processing sequence on the drive side in the content recording/reproduction process involving content transfer between the host and the drive.

FIG. 14 is a flowchart illustrating a processing sequence on the drive side in the content recording/reproduction process involving content transfer between the host and the drive.

FIG. 15 shows an example of the configuration of an information processing apparatus serving as a host according to the present invention.

FIG. 16 shows an example of the configuration of an information processing apparatus serving as a drive according to the present invention.

### BEST MODE FOR CARRYING OUT THE INVENTION

With reference to the drawings, a description will be given below of an information processing apparatus an information processing method, and a computer program according to the present invention. The description is given in accordance with the following items.

1. Outline of processing in accordance with CPRM definition

2. Configuration for processing involving content transfer between a drive and a host according to the present invention

3. Configuration of an information processing apparatus

[1. Outline of Processing in Accordance with CPRM Definition]

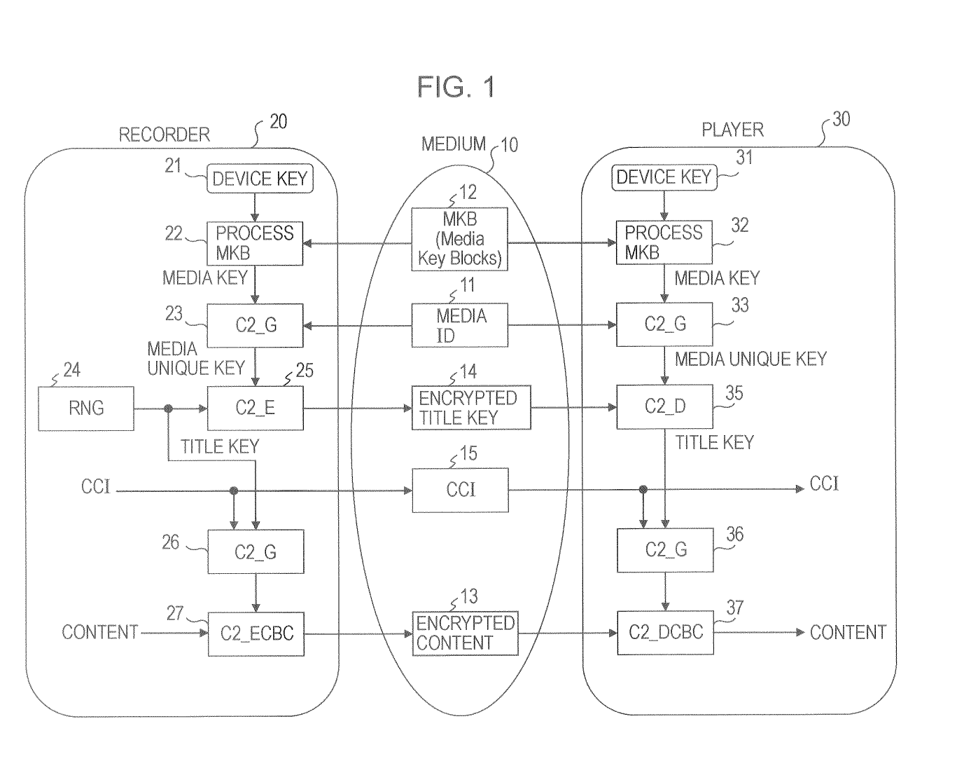

In order to facilitate the understanding of the present invention, with reference to FIG. 1, the architecture of content protection for recordable media (CPRM) known as a copyright protection technology that supports, for example, a medium (information recording medium) such as a DVD will be described.

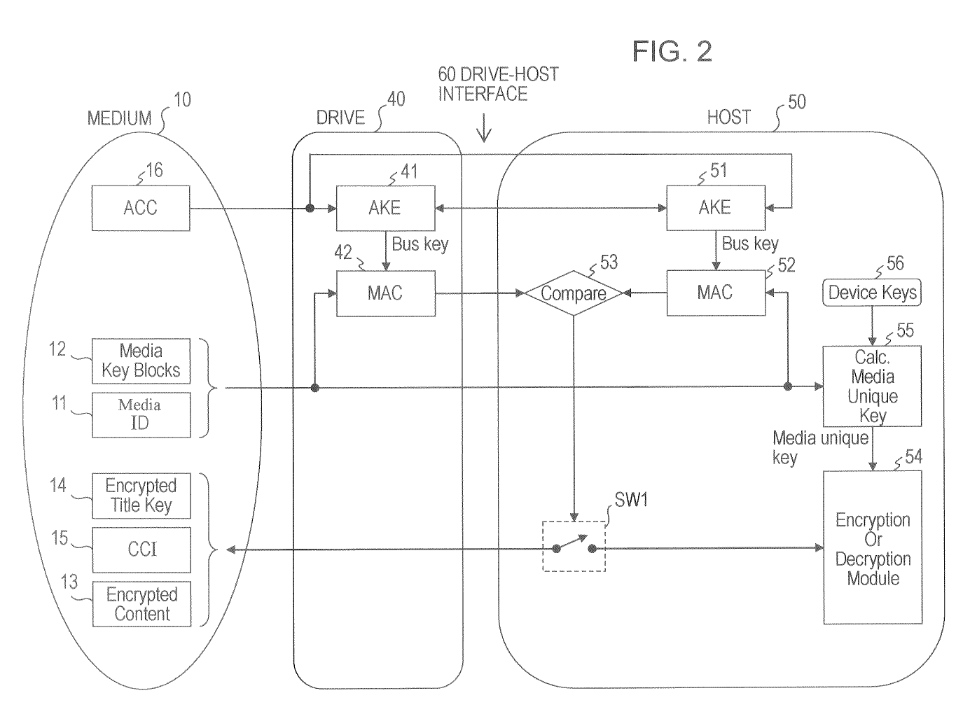

There are two types of processing for reproducing and recording content from and onto a medium information recording medium): a first type of processing that uses a recording/reproduction apparatus in which a drive for driving an information recording medium (disc) and reproduction/recording process functions are integrated; and a second type of processing in which a drive and an information processing apparatus, for example, a PC, serving as a host for executing a reproduction or recording processing program are connected to each other via a bus, the second type of processing involving data transfer between the drive and the host. Referring to FIG. 1, a data recording/reproduction process in the first type of processing will be described. Referring to FIG. 2, a data recording/reproduction process in the second type of processing will be described.

In FIG. 1, in the center, a recordable medium (information recording medium) 10, such as a DVD-R/RW or a DVD-R M in compliance with CPRM, is shown. On the left side, a recorder 20 in compliance with CPRM is shown. On the right side, a player 30 in compliance with CPRM is shown. The recorder 20 and the player 30 are devices or application software.

In the state of being an unrecorded disc, a media ID 11 is recorded upon in an area referred to as a burst cutting area (BCA) or a narrow burst cutting area (NBCA) of a lead-in area in the innermost peripheral region of the medium 10. In the embossed or prerecorded data zone of the lead-in area, media key blocks (hereinafter abbreviated as “MKBs” as appropriate) 12 are prerecorded. The media ID 11 is a number different in units of individual media, for example, for each disc, and is composed of a medium manufacturer code and a serial number. The media ID 11 becomes necessary when the media key is converted into a medium unique key different for each medium. The media key block MKB is encrypted key block data for realizing extraction of the media key and revocation of a device. The media ID is information specific to each medium (recording medium).

On the medium 10, in a data rewritable or recordable data area, encrypted content 13 encrypted using a content key is recorded. For the encryption method, for example, C2 (Cryptomeria Cipher) is used.

On the medium 10, an encrypted title key 14 and CCI (Copy Control Information) 15 are recorded. The encrypted title key 14 is encrypted title key information, and the title key information is key Information attached for each title. CCI is copy control information, such as copy no more, copy once, or copy free.

The recorder 20 includes a device key 21, a process MKB 22, C2_G 23, a random number generator 24, C2_E 25, C_G 26, and C2_ECBC 27. The player 30 includes a device key 31, a process MKB 32, C2_G 33, C2_D 35, C2_G 36, and C2_DCBC 37.

The device keys 21 and 31 are secret keys that are different for each apparatus manufacturer or for each application software vendor, and are issued from a key management center. Each device key has information specific to an electronic device or application software, which is provided to only the electronic device or the application software by a license manager. Since the MKB 12 and the device key 21 reproduced from the medium 10 are computed in the process MKB 22, it is possible to determine whether or not a revocation has been made. Similarly to that in the recorder 20, also, in the player 30, the MKB 12 and the device key 31 are computed in the process MKB 32, and it is determined whether or not a revocation has been made.

Furthermore, in the process MKBs 22 and 32, media keys are computed on the basis of the MKB 12 and the device keys 21 and 31, respectively. When the device key is a valid device key, that is, when the device key has not been revoked, it is possible for the MKB 12 to obtain the media key by decryption using the valid device key.

Therefore, when the device key 21 of the recorder 20 has been revoked, in the process MKB 22, the media key cannot be computed from the MKB 12 and the device key 21. Similarly, when the device key 31 of the player 30 has been revoked, in the process MKB 32, the media key cannot be computed from the MKB 12 and the device key 31. Only when the recorder 20 and the player 30 have a valid device key, it is possible to obtain a media key from the MKB 12.

The C2_G 23 and the C2_G 33 are each processes for computing a media key and a media ID and for extracting a medium unique key.

A random number generator (RNG) 24 is used to generate a title key. The title key from the random number generator 24 is input to the C2_E 25, and the title key is encrypted using the medium unique key. The encrypted title key 14 is recorded on the medium 10.

In the player 30, the encrypted title key 14 and the medium unique key reproduced from the medium 10 are supplied to the C2_D 35, where the encrypted title key is decrypted using the medium unique key, and a title key is obtained.

In the recorder 20, CCI and the title key are supplied to the C2_G 26, where a content key is extracted. The content key is supplied to the C2_ECBC 27, and content is encrypted by using the content key as a key. The encrypted content 13 is recorded on the medium 10.

In the player 30, CCI and the title key are supplied to the C2_G 36, and a content key is extracted. The content key is supplied to the C2_ECBC 37, where the encrypted content 13 reproduced from the medium 10 is decrypted by using the content key as a key.

The procedure for recording content by the recorder 20 in the configuration of FIG. 1 will be described. The recorder 20 reads the MKB 12 from the medium 10, and computes the device key 21 and the MKB 12 by using the process MKB 22 in order to calculate the media key. When obtaining of the media key fails (the computation result shows a preset value), it is determined that the device key 21 (the device of the recorder 20 or the application has been revoked by the MKB, and the recorder 20 stops the subsequent processing and prohibits recording onto the medium 10. When the media key is obtained (other than a preset value), the recorder 20 continues the processing.

Next, the recorder 20 reads the media ID 11 from the medium 10, inputs the media ID together with the media key to the C2_G 23, and a medium unique key different for each medium is computed. The title key generated by the random number generator 24 is encrypted by the C2_E 25 and is recorded as the encrypted title key 14 on the medium 10. Furthermore, the title key and the CCI information of the content are computed by the C2_G 26, and a content key is extracted. The content is encrypted using the content key by the C2_ECBC 27, and is recorded as the encrypted content 13 together with the CCI 15 on the medium 10.

Next, a reproduction procedure by the player 30 will be described. Initially, the MKB 12 is read from the medium 10, and the device key 31 and the MKB 12 are computed to confirm whether a revocation has been made. When the device key 31, that is, the device or the application of the player 30, has not been revoked, a medium unique key is computed using the media ID, and a title key is computed from the read encrypted title key 14 and the medium unique key. The title key and the CCI 15 are input to the C2_G 36, and a content key is extracted. The content key is input to the C2_DCBC 37, and the computation of C2_DCBC 37 is performed on the encrypted content 13 reproduced from the medium 10 by using the content key as a key. As a result, the encrypted content 13 is decrypted.

As described above, in order to obtain a content key necessary for decrypting content, a media ID different for each medium becomes necessary. Therefore, for example, even if encrypted content on a medium is faithfully copied to another medium, since the media ID of the other medium differs from the original media ID, the copied content cannot be decrypted, and therefore, the copyright of the content can be protected.

The above-described configuration of FIG. 1 shows processing for reproducing and recording content from and onto a medium (information recording medium) in the case of being configured as a recording/reproduction device. Next, a description will be given of a data recording/reproduction process in the second type of processing in which a drive and an information processing apparatus, such as a PC serving as a host for executing a reproduction or recording program, are connected to each other via a bus, the second type of processing involving data transfer between the drive and the host.

In FIG. 2, a host 50 serving as a data processing apparatus is shown as, for example, a PC. The host 50 is an apparatus or application software that is capable of handling content that can be recorded onto the medium 10 and can be reproduced from the medium 10 and that is connected to the drive 40 so that data can be exchanged. As a result of application software being installed into, for example, a PC, the host 50 is configured.

The drive 40 and the host 50 are connected to each other via an interface 60. Examples of the interface 60 include an ATAPI (AT Attachment Packet Interface) a SCSI (Small Computer System Interface), a USB (Universal Serial Bus), and IEEE (Institute of Electrical and Electronics Engineers) 1394.

On the medium 10, the media ID 11, the media key block 12, and ACC (Authentication Control Code) are recorded in advance. ACC is data recorded in advance on the medium 10 so that authentication between the drive 40 and the host 50 is different for each medium 10.

The drive 40 reads ACC 16 from the medium 10. The ACC 16 read from the medium 10 is input to AKE (Authentication and Key Exchange) 41 of the drive 40 and is transferred to the host 50. The host 50 inputs the received ACC to AKE 51. AKEs 41 and 51 exchange random number data and generate a common session key (referred to as a bus key) that becomes a different value each time an authentication operation is performed on the basis of the exchanged random number and the value of the ACC.

The bus key is supplied to MAC (Message Authentication Code) computation blocks 42 and 52. The MAC computation blocks 42 and 52 are processes for calculating the MACs of the media ID and the media key block 12 by using the bus keys obtained in the AKEs 41 and 51 as a parameter, respectively. These are used for the host 50 to confirm the integrity of the MKB and the media ID.

The MACs calculated by the MACs 42 and 52 are compared with each other by a comparator 53 of the host 50, and it is determined whether or not the two values match each other. When these values of the MACs match each other, the integrity of the MKB and the media ID is confirmed. A switch SW1 is controlled by comparison output.

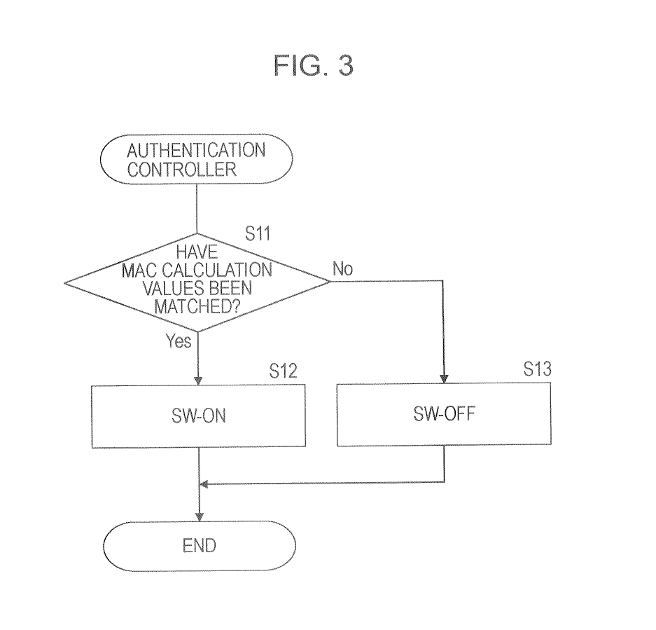

A description will now be given, with reference to the flowchart in FIG. 3, of a switch control process on the basis of MAC verification. Step S11 is a process of the comparator 53 of the host 50 and is a step of comparing a MAC calculation value determined in the MAC computation block 42 of the drive 42 by using the bus key as a parameter with a MAC calculation value determined in the MAC computation block 53 of the host 50 by using the bus key as a parameter. When they match each other, it is determined that the integrity of the MKB and the media ID is confirmed. Then, the process proceeds to step S12, where the switch SW1 is turned on. When they do not match each other, it is determined that the integrity of the MKB and the media ID is not confirmed. Then, the process proceeds to step S13, where the switch SW1 is turned off, and the processing is stopped.

The switch SW1 is shown so as to connect/disconnect the signal path between the recording or reproduction path of the medium 10 of the drive 40 and an encryption/decryption module 54 of the host 50. Although the switch SW1 is shown so as to connect/disconnect the signal path, more practically, it is shown that, in the case of ON, the processing of the host 50 is continued, and in the case of OFF, the processing of the host 50 is stopped. The encryption/decryption module 54 is a computation block for computing a content key on the basis of the medium unique key, the encrypted title key, and the CCI, for encrypting the content into the encrypted content 1 by using the content key as a key, and for decrypting the encrypted content 13 by using the content key as a key.

The medium unique key computation block 55 is a computation block for computing a medium unique key on the basis of the MKB 12, the media ID, and a device key 56. That is, similarly to the recorder or the player shown in FIG. 1, a media key is computed on the basis of the device key and the MKB 12, and a medium unique key is computed on the basis of the media key and the media ID 11. When the media key becomes a predetermined value, it is determined that the electronic device or the application software is not authorized and is revoked. Therefore, the medium unique key computation block 55 also has a function as a revocation processor for performing a revocation.

During recording, when the integrity is confirmed by the comparator 53, the switch SW1 is turned on. The encrypted content 13, the encrypted title key 14, and the CCI 15 are supplied from the encryption/decoding module 54 to the drive 40 via the switch SW1, and they are recorded on the medium 10. During reproduction, when the integrity is confirmed by the comparator 53, the switch SW1 is turned on. The encrypted content 13, the encrypted title key 14, and the CCI 15, each of which is reproduced from the medium 10 are supplied to the encryption/decoding module 54 of the host 50 via the switch SW1, and the encrypted content is decrypted.

In the above-described process, the media ID 11 recorded on the medium 10 is provided as is maintained as plain text to the host 50 via the drive 40. In such a configuration as described above, it becomes possible for the host that has obtained the media ID to estimate the correspondence between the media ID and the media key.

The media ID is identification data different for each medium and is recorded in an area referred to as a BCA (Burst Cutting Area) or a NBCA (Narrow Burst Cutting Area) of the lead-in area in the innermost peripheral region of the medium, in which writing is not possible by a normal process.

The media key is a key that can be obtained from an MKB, and the MKB is set as common data for a plurality of media. For example, in discs (media) manufactured by a certain disc manufacturer, the same MKB is stored for certain manufacturing lot units and for certain fixed periods, and an MKB from which the same media key can be obtained is used.

While the host is not revoked and is a valid device, it is possible to obtain a plurality of media IDs from various media. Furthermore, when authorized CPRM recording software, that is, a program used when encrypted content in compliance with CPRM is to be recorded on a medium is analyzed, and the processing sequence of CPRM is analyzed, there is a possibility that, by using the analyzed CPRM recording software, media keys that are recorded in secrecy in MKBs (Media Key Blocks) of many CPRM recording discs are extracted.

As a result, data of the correspondences between the media IDs and the media keys is, for example, as described below:

Media ID: aaaa to bbbb=media key X

Media ID: cccc to dddd=media key Y

Media ID: eeee to ffff=media key Z

There is a possibility that such correspondences between the range of media IDs and the media keys are estimated.

Furthermore, by using the analyzed authorized CPRM recording software, CPRM recording software is illegally user-created without receiving a license. The following are made possible by the illegally created software. A media ID recorded in the BCA of the CPRM recording disc (data writable disc in compliance with CPRM) is read. The read media ID is transmitted to a management server in which the correspondences between media IDs and media keys are held as a database A media key corresponding to the media ID is transmitted from the server. By using the illegally obtained media key, encrypted content is created in accordance with a data encryption and recording sequence in compliance with CPRM and is recorded on a medium. As a result of the processing by using the media key obtained from the server, it becomes possible to record the encrypted content onto a medium such as a CPRM-compliant DVD without performing an MKB process using a device key. Consequently, CPRM-compliant media are manufactured by a device having no valid license.

[2. Configuration for Processing Involving Content Transfer Between a Drive and a Host According to the Present Invention]

The present invention described below has a configuration for solving the above-described problems. The outline of the configuration of the present invention will be described first.

In the configuration of the present invention the media ID recorded in the burst cutting area (BCA) of the lead-in area in the innermost peripheral region of the medium is not transferred as is maintained as plain text from the drive to the host, but the media ID is encrypted and output to only the authenticated host. With this configuration. It is possible to prevent the media ID from being obtained by an unauthorized host so that the correspondences between the media IDs and the media keys cannot be estimated.

More specifically when the media ID recorded in the BCA is to be transferred from the drive to the host, the media ID is encrypted using a session key (Ks) that is generated after the mutual authentication and key exchange (AKE) between the host and the drive is completed, and is securely transferred from the drive to the host. As a result a theft of the media ID from the I/F bus, such as ATAPI, which is a connection interface between the drive and the host, is prevented. With this configuration, it makes not possible to estimate the correspondences between the media IDs and the media keys.

Data other than the media ID can be recorded in the BCA. For example, information on the medium recording type, such as BD-ROM (read only), BD-RE (rewritable), or BD-R (write once), is recorded. Data other than confidential information such as the media ID can be transferred from the drive to the host independently of the completion of the mutual authentication and key exchange (AKE) between the host and the drive. However, the BCA data area other than the header code of the media TD is not made public. These data formats can be known only in, for example, a disc manufacturing entity that has received a copy protection technology license. If the BCA data format is made public to all the users receiving a license of only the physical standard a person not receiving a copy protection technology license inadvertently uses the same header information as the media ID, and interference in terms of management in which an authorized copy protection technology is applied is assumed to occur.

Therefore, when a license of only the physical standard is received, it is necessary that header code information differing from the header code corresponding to the media ID is forcedly used and free management in the permissible range of the physical standard license does not receive a conflict in terms of use with a media ID specified by the copy protection standard license. That is, the BCA data specified by the physical standard is assumed to be managed under a header different from the header of the media ID defined by the copy protection standard.

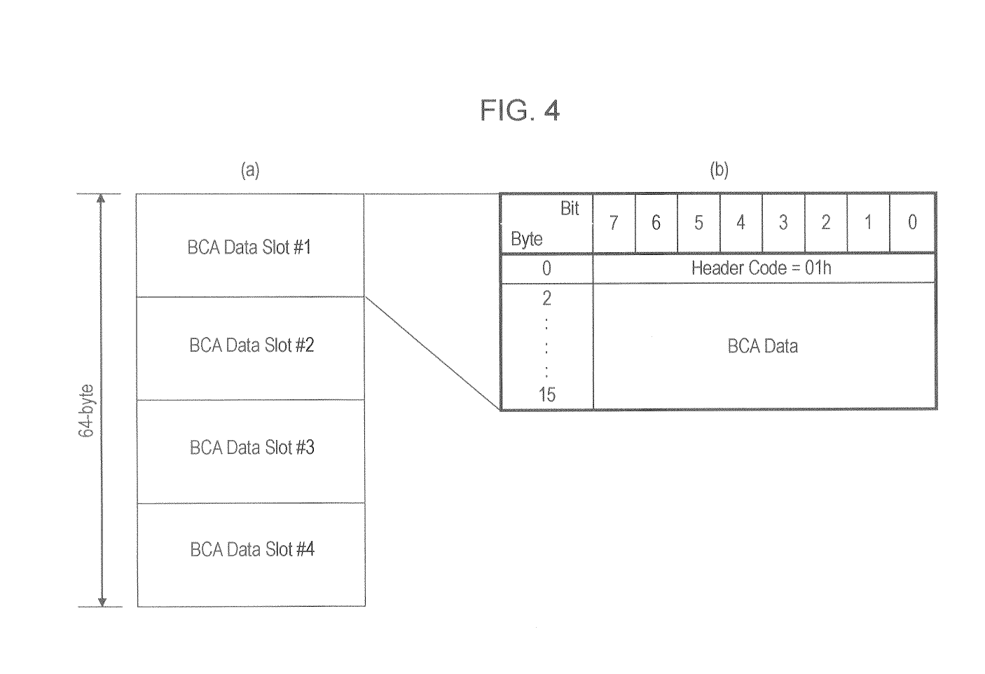

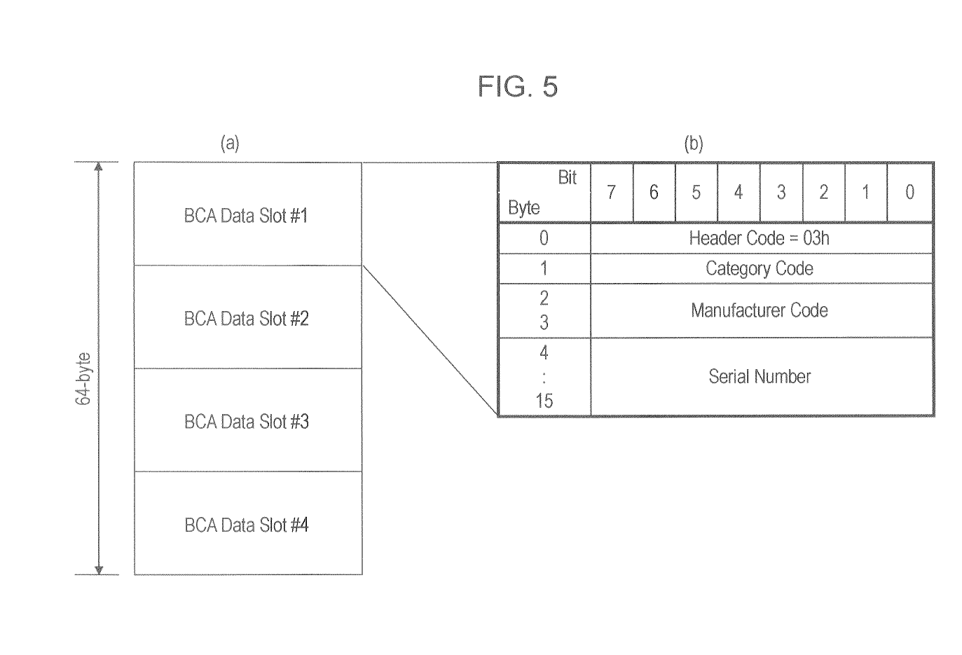

A description will now be given, with reference to FIGS. 4 and 5, of the format of a media ID to be recorded in a BCA of a medium (disc).

FIG. 4 shows the data recording structure of the BCA. As shown in FIG. 4(a), the BCA has four slots capable of recording 16-byte data. Data of a total of 64 bytes can be recorded. As described above, the BCA is based on a special data recording method different from a typical data recording process, and only the disc manufacturing entity receiving a license can perform a recording process.

As shown in FIG. 4(b), the data structure of each slot is formed of a header part and a BCA data part. The header part is used as data for identifying the type of data stored in the BCA data part.

For example, in the header part, various one-byte codes are stored. Some of them are set as code (03h, etc) that is made public, which is used to specify BCA data used by the copyright protection technology, and in the BCA data area following the header part, data corresponding to the header code is stored.

FIG. 5 shows the data recording structure of a BCA in which a media ID is stored. Similarly to FIG. 4(a), FIG. 5(a) shows the overall structure of a CPA area. FIG. 5(b) shows the data structure of a media ID storage slot. The media ID is sometimes referred to as a disc ID.

In the header storage part of the media ID (disc ID) storage slot shown in FIG. 5(b), header code=03h indicating that the slot storage data is data, such as the media ID (disc ID), which is used for the copyright protection technology, is stored. When the header code indicates that the BCA slot storage data is data used for the copyright protection technology, such as for the media ID, the BCA data area other than the header code is not made public and is set as a BCA data part that can be known by only a specific license holding entity, such as a licensed disc manufacturing entity. The structure of data from byte 2 to byte 15 is classified according to a category code. When the category code is a predetermined value (for example, 01h), the BCA slot data is classified as a media ID. In the BCA data part when the BCA slot data is a media ID, as the data constituting the media ID, category code, manufacturer code, and a serial number are stored. The meaning of each piece of data is as follows:

The category code: classification code of data used for copyright protection technology

The manufacturer code: an identification code distributed for each disc manufacturer

The serial number: a serial number of a disc manufactured by the disc manufacturer

The processing of the present invention features the following configuration.

(1) The BCA data area other than the header data of the BCA data having header data 03h is confidential.

(2) The drive does not transfer BCA data having header data=03h to the host when AKE is completed and a session key Ks has not been generated.

(3) If AKE is completed and the session key Ks is generated, the drive transfers BCA data having header data 03h to the host after the BCA data is encrypted using Ks.

(4) It is possible for the drive to transfer BCA data having header data other than 03h, as is, to the host without encrypting it regardless of the completion of the AKE. That is, the BCA data is not confidential.

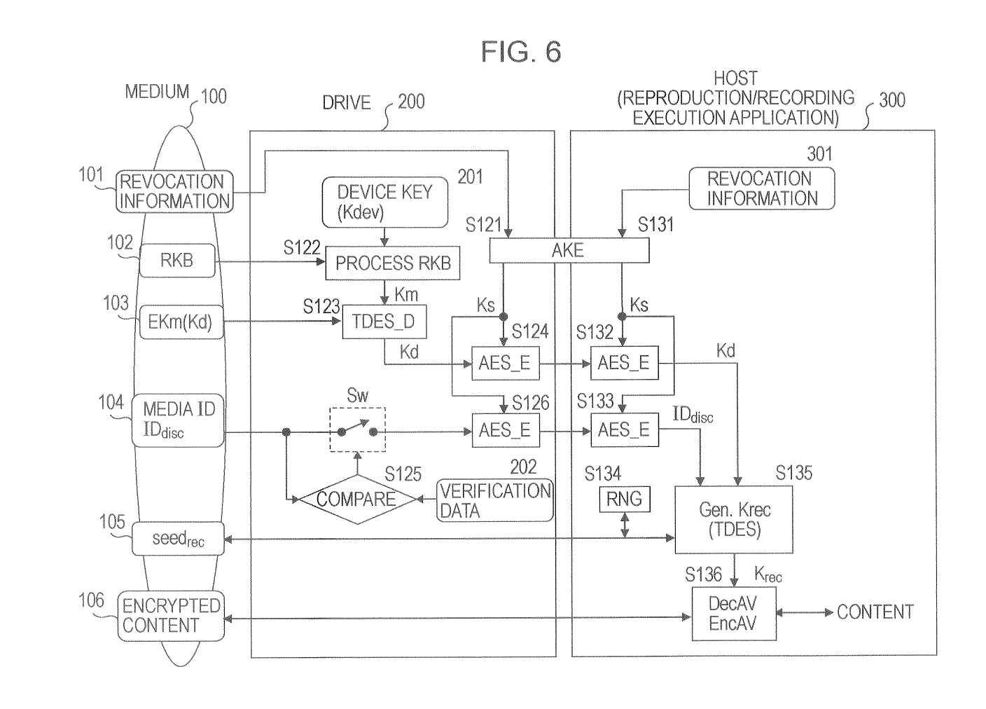

Next, a description will be given, with reference to FIG. 6 and subsequent figures, of details of processing involving content transfer between a drive and a host according to the present invention. FIG. 6 illustrates processing for transferring content between a drive and a host, which are connected to each other via a bus, and for reproducing or recording the content from or onto a medium.

FIG. 6 shows processing of a medium (information recording medium) 100, a drive 200 for reading or writing data from or onto the set medium 100, and a host 300, which is connected to the drive 200 via a connection bus, for performing a content reproduction or recording process in accordance with an application program Examples of the bus for connecting between the drive 200 and the host 300 include an ATAPI (AT Attachment Packet Interface), a SCSI (Small Computer System Interface), a USB (Universal Serial Bus), and IEEE (Institute of Electrical and Electronic Engineers, Inc.).

On the medium 100, the following information is stored

revocation information 101 for identifying a valid device or a revoked device,

RKB 102 serving as an encrypted key block in which a media key (Km) is stored,

an encrypted disc key EKm(Kd) 103 such that the disc key (Kd) is encrypted using the media key (Km),

a media ID (IDdisc) 104 recorded in the BCA area,

seed information (Seedrec) 105 used for generating a recording key (Krec) serving as an encryption key used for a content encryption or decryption process, and

encrypted content 106.

When the medium 100 is a medium on which encrypted content has been recorded, the seed information (Seedrec) 105 and the encrypted content 106 have been recorded on the medium 100. When the medium 100 is a data writable medium on which content has not been written, these pieces of data have not been written. When encrypted content generated by the host 300 is to be recorded on a medium, a random number generated by the host is recorded as seed information (Seedrec) 105 on the medium 100, and encrypted content encrypted using the recording key (Krec) is recorded on the medium 100.

The revocation information 101 is data such that registration or revocation information of each device is recorded, and has structure such that an electronic signature of the management center is attached and verification against falsification is possible.

The RKB (Renewal Key Block) 102 is encrypted key block data similar to the above-described media key block (MKB), and is an encrypted key block generated on the basis of a tree-structure key-distribution system known as one type of a broadcast encryption system. Similarly to the MKB, the media key: Km can be obtained by a decryption process using a device key distributed to the information processing apparatus serving as a user device having a valid license for reproducing/recording content using a medium (information recording medium). By changing data constituting the encrypted key block: RKB, it is possible to select a user device capable of obtaining the media key: Km. That is, when the device key of the revoked device is used, the RKB is updated as necessary so that the media key: Km cannot be obtained.

When the management center determines that the device (user device or reproduction application) for performing content reproduction/recording is unauthorized, it is possible to make obtaining of the media key: Km by the unauthorized device to be not possible by changing the structure of the RKB. The device that is determined to be unauthorized is registered as a revoked device in the management center. The management center holds registration information and revocation information of devices and update them as appropriate.

The media ID 104 is medium-specific identification information recorded in the BCA area. The media ID, as stated above, is also referred to as a disc ID, and is data that can be recorded by only a medium (disc) manufacturing entity receiving a license.

In the drive 200; a device key 201 and verification data 202 are stored. These are securely stored in a non-volatile memory and are stored as data to which external access and external falsification are not permitted. The device key 201 is a key used for the above-described RKB decryption process. When the authentication is ensured, that is, only when the drive is not revoked, the media key (Km) can be obtained from the RKB.

The verification data 202 is data to be stored in the drive for the purpose of a process for verifying the media ID (IDdisc) read from the BCA of the medium 100. The verification data 202 is structured as data containing code corresponding to the header code when the BCA data described above with reference to FIG. 5(b) is a media ID. That is, in this example, the header code when the BCA data is a media ID is 03h, and 03h is stored as the verification data 202 in the memory of the drive 200.

As described above, when the BCA data is a media ID, the BCA slot data other than the value [03h] of the header code is not a public value, and, for example, disc manufacturing is obligated under the management of a disc manufacturing entity based on a contract with the management center together with the device key 201. Furthermore the drive manufacturing entity receiving a license from the management center is obligated to store the value of the header code in the memory (non-volatile memory) of each drive and to perform appropriate transfer control for the BCA data read from the disc.

The host (reproduction/recording execution application) 300 has stored therein revocation information 301. This information is data such that the registration or revocation information of each device is recorded, has a structure such that the electronic signature of the management center is attached and falsification verification is possible, and is used as reference information under the condition that falsification verification is performed and the authentication is confirmed.

Although not shown in the figure, the drive 200 and the host 300 each have stored therein a pair of their own public key and secret key in accordance with a public key encryption method. Furthermore they have stored therein the public key of the management center, which is used for the signature verification of the public key certificate, used for the signature verification of the revocation information, and the like, which are externally obtained.

A description will now be given, with reference to FIG. 6, of a processing sequence for reproducing content from the medium 100 and for recording content onto the medium 100.

Initially, in steps S121 and S131, mutual authentication key exchange (AKE) processes are performed between the drive 200 and the host 300.

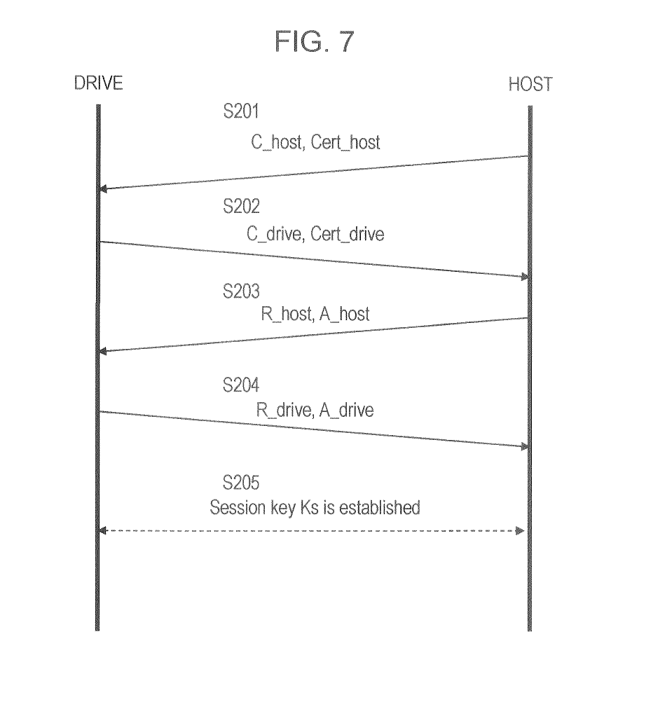

A description will now be given, with reference to FIG. 7, a detailed sequence of a mutual authentication key exchange (AKE) process. The process can be performed by applying a mutual authentication system using, for example, a public key algorithm specified in ISO/IEC9798-3 and by applying a key generation system using a public key algorithm specified in ISO/IEC11770-3. As a method that has been implemented as a mutual authentication method using a public key, for example, there is a known method described in DTCP (Digital Transmission Content Protection) Specification Volume 1 (Informational Version).

The processing sequence shown in FIG. 7 will be described. In step S201, the host transmits, to the drive, challenge data [C_host] generated by a random number generation process, and a public key certificate [Cert_host].

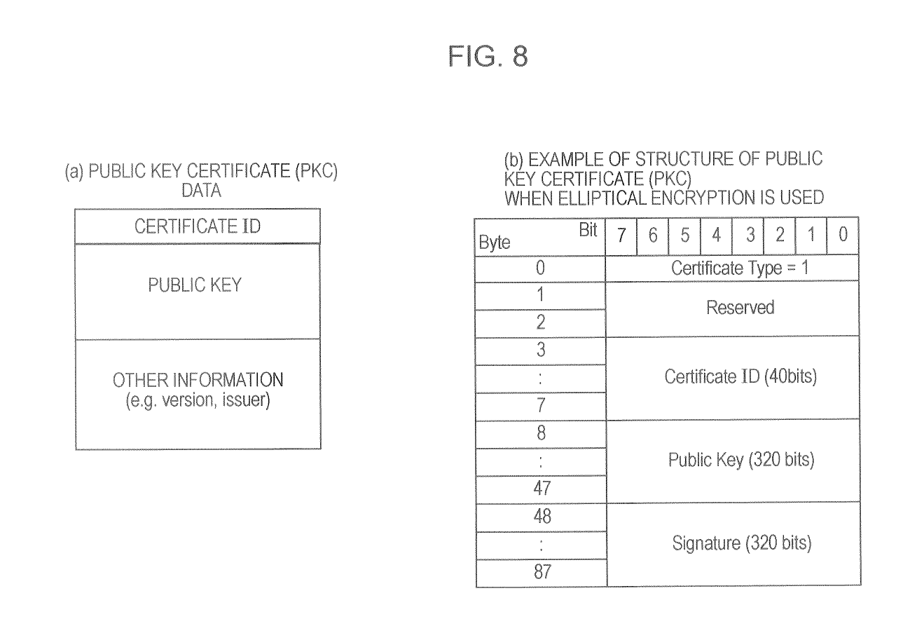

A description will now be given, with reference to FIG. 8, of the data structure of a public key certificate (PKC). FIG. 8(a) shows an example of certificate data of the public key certificate (PKC). FIG. 8(b) shows an example of the data structure of the public key certificate (PKC) to which elliptical encryption (key length: 160 bits) is applied.

As shown in FIG. 8(a), the certificate data of the public key certificate (PKC) contains a certificate ID, a public keys and other information. For example, the drive receives a public key certificate (PKC-D) storing a public key corresponding to the drive from the management center and stores it in a non-volatile memory such as a flash memory. Furthermore, a secret key (KS-D) corresponding to the public key is also provided. A pair of the public key certificate (PKC) and the secret key is also provided to the host, and it is stored in a non-volatile memory such as a hard disk or in a flash memory in the host.

The public key certificate (PKC) is data that can be made public and is output, for example, in response to a request from another device. The device receiving the public key certificate of the other device performs falsification verification of the public key certificate on the basis of the signature of the management center, which is attached to the received public key certificate, and obtains the public key on the basis of the public key certificate after the authentication of the received public key certificate is confirmed. The falsification verification of the public key certificate on the basis of the signature of the management center is performed by using the public key of the management center. The public key of the management center is also data that is made public. For example, data prestored in a non-volatile memory or the like of a drive or a host is used. Alternatively, the public key can be received via a network or a recording medium.

The secret key is provided together with the public key certificate to the drive and the host. That is, a pair of the public key certificate (PKC) and the secret key is provided to the drive and the host and is stored in their respective memories. The public key certificate storing the public key is data that can be made public. The secret key is securely stored in each device so that it will not be leaked externally.

FIG. 8(b) shows an example of the data structure of the public key certificate (PKC) to which elliptical encryption (key length: 160 bits) is applied. A certificate type Certificate Type=1), a certificate ID (Certificate ID), and a public key (Public Key) are stored, and an electronic signature that is generated by using the secret key of the management center in such a manner as to correspond to these pieces of the stored data is set.

Referring back to FIG. 7, the description of the mutual authentication sequence will be continued. In step S201, the drive receiving the challenge data [C_host] and the public key certificate [Cert_host] from the host verifies the validity of the public key certificate [Cert_host] by the signature verification process of the public key certificate [Cert_host]. The signature verification process is performed by using the public key of the management center, which is held by the drive.

When the validity of the public key certificate [Cert_host] is verified, the drive obtains the public key certificate ID from the public key certificate [Cert_host] and confirms whether the public key certificate ID of the host has not been recorded in the revocation information 101 read from the medium 100. That is, it is confirmed whether or not the public key certificate ID of the host is a valid ID that has not been revoked.

When the validity of the public key certificate [Cert_host] is not confirmed or when it is determined that the host has been revoked on the basis of the revocation information 101, an error message is reported, and the processing is completed. The subsequent content reproduction or recording process is stopped.

When the validity of the public key certificate [Cert_host] is confirmed and the host is confirmed to be a host having a valid public key certificate that has not been revoked, in step S202, the drive transmits, to the host, challenge data [C_drive] generated by the random number generation process and the public key certificate [Cert_drive] on the drive side.

The host performs signature verification of the public key certificate [Cert_drive] on the drive side. The signature verification process is performed by using the public key [Kp_kic] of the management center, which is held on the host side.

When the validity of the public key certificate [Cert_drive] is confirmed, the public key certificate ID is obtained from the public key certificate [Cert_drive]. It is verified against the revocation information 301 in order to confirm whether or not the public key certificate ID of the drive is a valid ID that has not been revoked.

When the validity of the public key certificate [Cert_drive] is not confirmed or when the drive is determined to be revoked on the basis of the revocation information 301, an error message is reported, and the processing is completed. The subsequent content reproduction or recording process is stopped.

When the validity of the public key certificate [Cert_drive] is confirmed, the host performs a computation on the basis of challenge data [C_drive] received from the drive in order to compute a parameter [A_host], and transmits it together with a newly generated random number [R_host] to the drive (step S203).

On the other hand, the drive performs a computation on the basis of the challenge data [C_host] received from the host in order to compute a parameter [A_drive], and transmits it together with a newly generated random number [R_drive] to the host (step S204).

As a result of the processing, both the drive and the host share the random numbers [R_host] and [R_drive] and the parameters [A_host] and [A_drive]. Both the drive and the host application generate a common session key Ks on the basis of the shared data (step S205).

Referring back to FIG. 6, a description will now be given of a content reproduction or recording processing sequence involving content transfer between the drive 200 and the host 300.

When the mutual authentication and key exchange (AKE) with the host 300 is completed, the drive 200 performs a process for decrypting the RKB 102 as an encrypted key block read from the medium 100 by using the device key: Kdev 201 held in the drive, and obtains a media key: Km from the RKB 102 in step S122. Only the device for which use of content is granted is able to obtain a media key: Km from the RKB 102. As described above, the device key possessed by a device revoked as an unauthorized device does not enable the media key that is encrypted and stored in the RKB to be decrypted, and thus the media key: Km cannot be obtained.

When obtaining of the media key: Km succeeds in step S122, next, in step S123, a process for decrypting the encrypted disc key: EKm(Kd) 203 obtained from the medium 100 is performed by using the obtained media key: Km, and a disc key: Kd is obtained. For the decryption process, for example, a triple DES (TDES) algorithm is used. In the figure, TDES indicates a triple DES encryption algorithm, AES indicates an AES encryption algorithm, [E] shown as a character following TDES and AES indicates an encryption process (Encryption), and [D] indicates a decryption process.

Next, in step S124, the drive 200 encrypts the disc key: Kd by using the session key (Ks) generated in the mutual authentication and key exchange (AKE) process, and transmits it to the host 300. This encryption process is performed by using, for examples an AES encryption algorithm.

Next, in step S125, the drive 200 performs a process for comparing the media ID (IDdisc) read from the medium 104 with the verification data 202 stored in the memory in the drive 200.

The drive 200 performs processes for reading the data stored in the media ID storage slot (see FIG. 5) from a plurality of BCA data storage slots, which is read from the BCA of the medium 104 and for comparing the header code thereof with the verification data 202 stored in the memory in the drive 200. As described above, the header code of the media ID storage slot (see FIG. 5) is a predetermined value [03]. The BCA data having this value as a header code can be known by the medium manufacturing entity receiving a license, but it is a value that cannot be known by an unauthorized disc manufacturer. In step S125, the drive 200 compares the header code with the value [03h] of the header code of the media ID storage BCA slot, which is stored as the verification data 202.

If the value of the header data read from the medium 100 matches the verification data [03h] stored in the drive, the medium 100 is determined to be a valid medium, the drive 200 closes the switch (SW), encrypts the media ID (IDdisc) using the session key (Ks), and outputs it to the host 300 (step S126).

On the other hand, when the value of the header data read from the medium 100 does not match the verification data [03h] stored in the drive, the medium 100 is determined to be a medium on which content recording reproduction using a copyright protection technology cannot be applied, the drive 200 opens the switch (SW), stops the output of the media ID (IDdisc) to the host 300, and stops all the subsequent processing. That is, the content reproduction or recording process is not performed.

Processing on the host 300 side will be described. When mutual authentication is established in the mutual authentication and key exchange (AKE) with the drive 200 in step S131, the host 300 shares a session key (Ks) with the drive 200. In step S132, the encrypted disc key received from the drive 200, that is, the disc key [EKs(Kd)] encrypted using the session key (Ks), is decrypted using the session key, and a disc key (Kd) is obtained.

In step S133, the encrypted media ID received from the drive, that is, the media ID [EKs (IDdisc)] encrypted using the session key (Ks), is decrypted using the session key, and a media ID (IDdisc) is obtained.

In step S135, a recording key (Krec) used for decrypting encrypted content or for encrypting content is generated. Subsequent to this process, processing different between content reproduction and content recording is performed.

First, processing during content reproduction will be described. During the content reproduction, in step S135, a recording key (Krec) is generated by an encryption process (triple DES (TDES) on the basis of seed information (Seedrec), a disc key (Kd), and a media ID (IDdisc) stored on the medium 105. When generating the recording key (Krec), the seed information (Seedrec) 105 stored on the medium 105 is received via the drive 200. The seed information is read in units of files in which predetermined content is stored, a recording key (Krec) is generated by using seed information for each file in which content is stored a decryption process in units of files in which content is stored is performed by using the generated recording key, and content decryption and reproduction are performed.

Next, in step S136, the encrypted content 106 stored on the medium 105 is received via the drive 200, a decryption process using the generated recording key (Krec) is performed to obtain content, and the content is reproduced.

Next, processing during the recording of content will be described. During the recording of content, thereafter, in step S135, a recording key (Krec) is generated by an encryption process (triple DES (TDES)) based on the seed information (Seedrec), the disc key (Kd), and the media ID (IDdisc), which are stored on the medium 105. In step S134, the random number generation process is performed, and seed information on the basis of the random number is generated. A recording key (Krec) when content to be recorded is to be encrypted in units of files storing content is generated In step S136, data, such as externally input content, is encrypted using the recording key in units of files in which content is stored.

The generated encrypted content is output to the drive 200 and is written onto the medium 100 by a data writing process in the drive 200. The random number generated in step S134 is written as the seed information 105 in such a manner as to correspond to the written encrypted content 106.

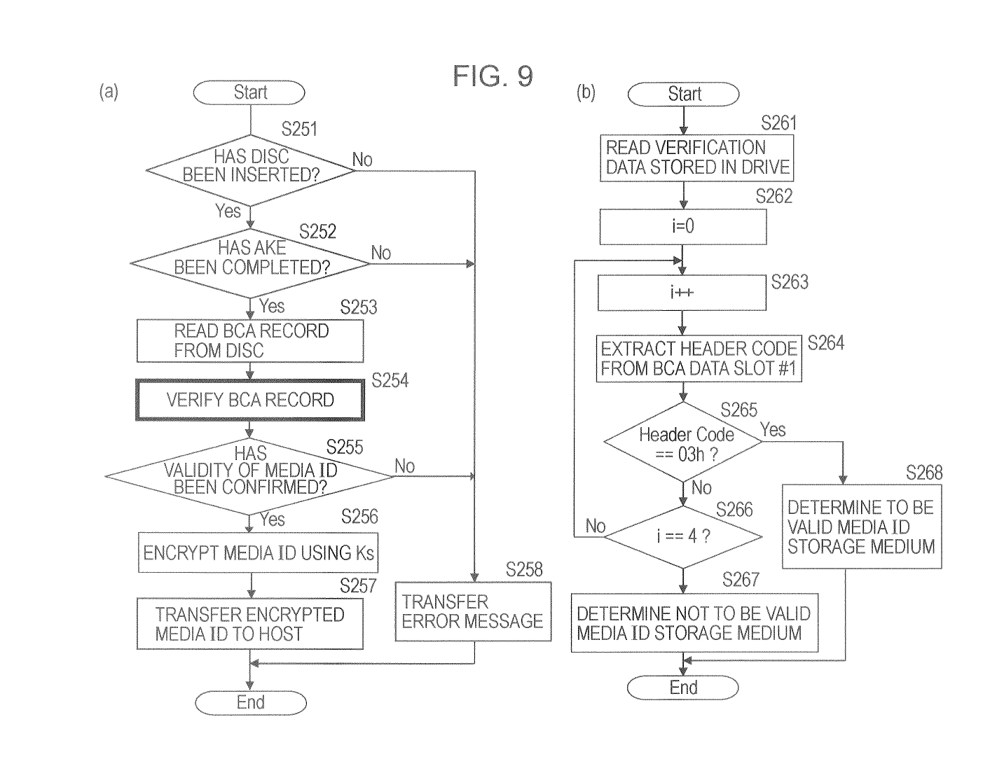

Next, a description will be given in detail, with reference to FIG. 9, of a sequence of verifying the media ID (IDdisc) 104 stored on the medium 100 in the drive and a sequence of outputting it to the host.

FIG. 9(a) shows an overall sequence of verifying the media ID (IDdisc) stored on a medium in the drive and of outputting it to the host. FIG. 9(b) is a flow illustrating details of a BCA recode verification process in step S254 of FIG. 9(a).

When the drive detects the insertion of a disc in step S251 of FIG. 9(a), a mutual authentication and key exchange (AKE) process with the host is performed in step S252. When the authentication is established and the session key (Ks) is shared, the process proceeds to step S253. When the authentication is not established the process proceeds to step S258, where an error message is reported to the host, and the processing is then completed.

When the authentication is established, the process proceeds to step S253, where the drive reads BCA slot data from the BCA of the medium (disc) and performs a process for verifying the BCA slot data in step S254. The details of the verification process will be described below with reference to the flow in FIG. 9(b).

Initially, in step S261, the verification data stored in the memory of the drive is read. This is verification data 202 shown in FIG. 6. As described above, the verification data is the value of the header corresponding to the media ID in the BCA recode ((03h) in this example).

In step S262, a variable (i) is Initialized to i=0. The variable i is a variable that is set to sequentially read a plurality of slots of the medium. As described above with reference to FIGS. 4 and 5, in the BCA of the medium, a plurality of slots in units of predetermined data are set, and the drive sequentially reads the slots (i=1 to 4).

In step S263, a process for updating the variable i is performed. First, it is set as i=1. Next, in step S264, the header code is obtained from the BCA slot #i of the medium. In step S265, it is determined whether or not the header code matches the verification data (the verification data 202 of FIG. 6) held by the drive, that is, whether or not the header code of the reading slot from the medium is equal to 03h.

When it is determined in step S265 that the header code of the reading slot from the medium is equal to 03h, the process proceeds to step S268, where the medium is determined to be a valid medium holding a correct header code corresponding to the media ID.

When it is determined in step S265 that the header code of the reading slot from the medium is not equal to 03h, the process proceeds to step S266, where it is determined whether or not the value of the variable i is the number of BCA slots=4. When i≠4, the process returns to step S263, where the variable i is updated, and header codes of different BCA slots are sequentially read and verified. When a header code equal to 03h is not detected until i=4 is reached, the process proceeds to step S267, where it is determined that the loaded medium does not hold a correct header code corresponding to the media ID, that is, the medium is a medium that cannot be used for recording or reproducing content in which copyright protection technology is applied.

After this processing the process proceeds to step S255 of FIG. 9(a). When it is confirmed in step S255 that the verification process shown in FIG. 9(b) has determined that the loaded medium is a valid medium holding a correct header code corresponding to the media ID, the process proceeds to step S256, where the media ID obtained from the BCA slot of the medium is encrypted using the session key (Ks), and the encrypted media ID is transferred to the host in response to a transfer request from the host in step S257.

When it is confirmed in step S255 that the verification process shown in FIG. 9(b) has determined that the loaded medium is a medium that does not hold a correct header code corresponding to the media ID, for which content recording/reproduction using copyright protection technology cannot be applied, the process proceeds to step S258, where an error message is transferred to the host in response to the transfer request from the host, and the processing is completed.

In the manner described above, when the drive is to output a media ID to the host, the drive verifies the header code of the BCA recode from the medium under the condition that the mutual authentication between the drive and the host has been established and the sharing of the session key has succeeded. Only when the header code matches data for verification held by the drive, the media ID, which is a BCA recode corresponding to the header code, is read and the read media ID is encrypted using the session key and is output to the host. The media ID output from the drive is data encrypted using the session key and the possibility of the media ID being externally leaked is reduced.

As described above since the BCA data having a header code corresponding to the media ID is data that is not made public, even when an unauthorized disc manufacturer has an apparatus capable of writing data into a BCA area, it is not possible to know a valid header code corresponding to the media ID, and a disc manufactured by such an unauthorized manufacturer does not have a header code (e.g. 03h) corresponding to the valid media ID. Furthermore, reproduction of content using such an invalid medium (disc) or recording of content onto such an invalid medium (disc) is eliminated.

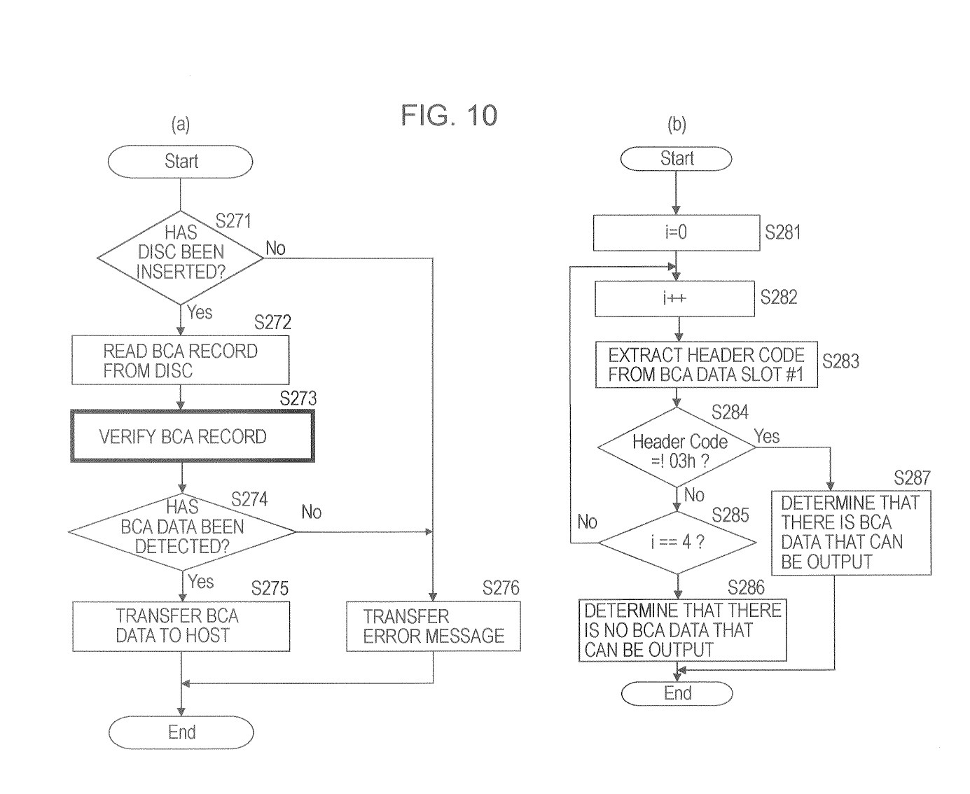

There are cases in which, in BCA recodes, not only the disc ID, but also other data is written, and some of BCA recodes contain data that can be made public. There is no particular limitation on outputting such data having a low level of secrecy, which is not related to copyright protection technology, to the host. FIG. 10 shows a flow illustrating processing when such BCA data having a low level of secrecy is output from the drive to the host.

FIG. 10(a) shows an overall sequence of outputting BCA data having a low level of secrecy other than the media ID (IDdisc) stored on a medium to a host FIG. 10(b) shows the details of a process for verifying a BCA recode in step S273 of FIG. 10(a). Here, header code≠03h is assumed to be a header code corresponding to the BCA data having a low level of secrecy.

When the drive detects the insertion of a disc in step S271 of FIG. 10(a), the process proceeds to step S272, where the drive reads BCA slot data from the BCA of the medium (disc) and performs a process for verifying a BCA slot recode in step S273. The details of the verification process will be described with reference to the flow of FIG. 10(b).

Initially, in step S281, a variable (i) is initialized to i=0. The variable i is a variable that is set to sequentially read a plurality of slots of a medium. In step S282, first, i=1 is set to perform a process for updating the variable i. Next, in step S283, a header code is obtained from the BCA slot #i of the medium. It is determined in step S284 whether or not the header code matches the header code (03h) corresponding to the BCA data having a low level of secrecy, that is, whether or not the header code of the reading slot from the medium is equal to 03h.

When it is determined in step S284 that the header code of the reading slot from the medium is not equal to 03h, the process proceeds to step S287, where it is determined that the medium holds BCA data that can be output.

When it is determined in step S284 that the header code of the reading slot from the medium is equal to 03h, the process proceeds to step S285, where it is determined whether or not the number of BCA slots=4. When i≠4, the process returns to step S282, where the variable i is updated, and header codes of different BCA slots are sequentially read and verified. When a header code that is not equal to 03h in not detected until i=4 is reached, the process proceeds to step S286, where it is determined that the loaded medium does not hold BCA data that can be output.

After this processing the process proceeds to step S274 of FIG. 10(a). When it is confirmed in step S274 that the verification process shown in FIG. 10(b) has determined that the loaded medium holds BCA data that can be output, the process proceeds to step S275, where the BCA data obtained from the BCA slot of the medium is transferred to the host in response to a transfer request from the host.

When it is confirmed in step S274 that the verification process shown in FIG. 10(b) has determined that the loaded medium does not hold BCA data that can be outputs the process proceeds to step S276, where an error message is transferred to the host in response to a transfer request from the host. The processing is then completed.

Next, a description will be given, with reference to individual flows of a content reproduction or recording process using a medium, which is performed by a drive and by a host.

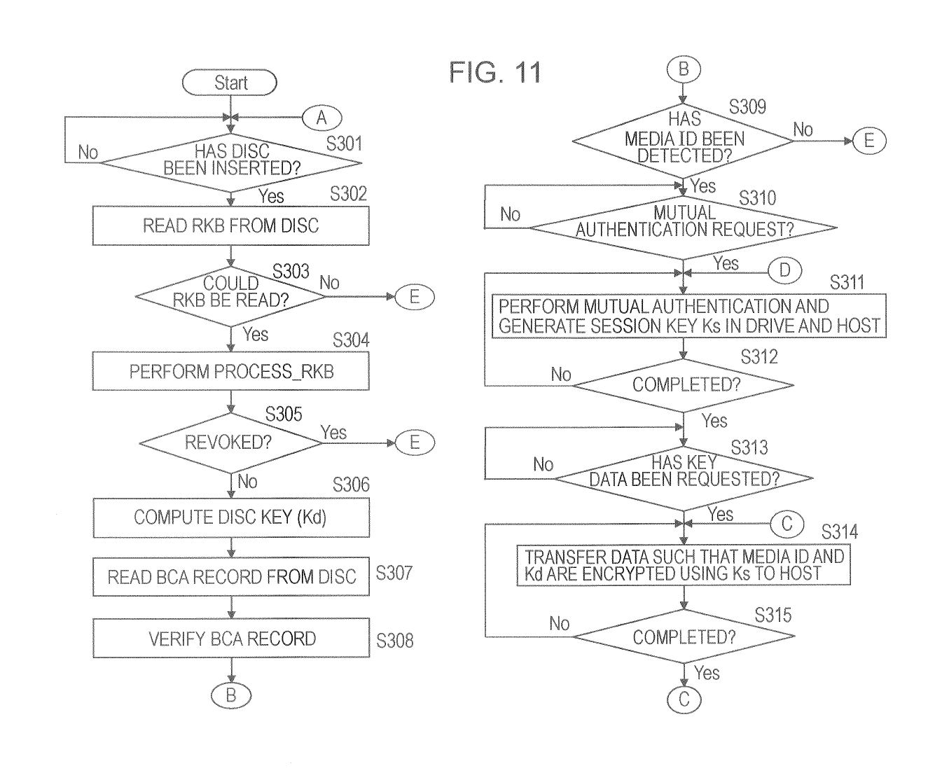

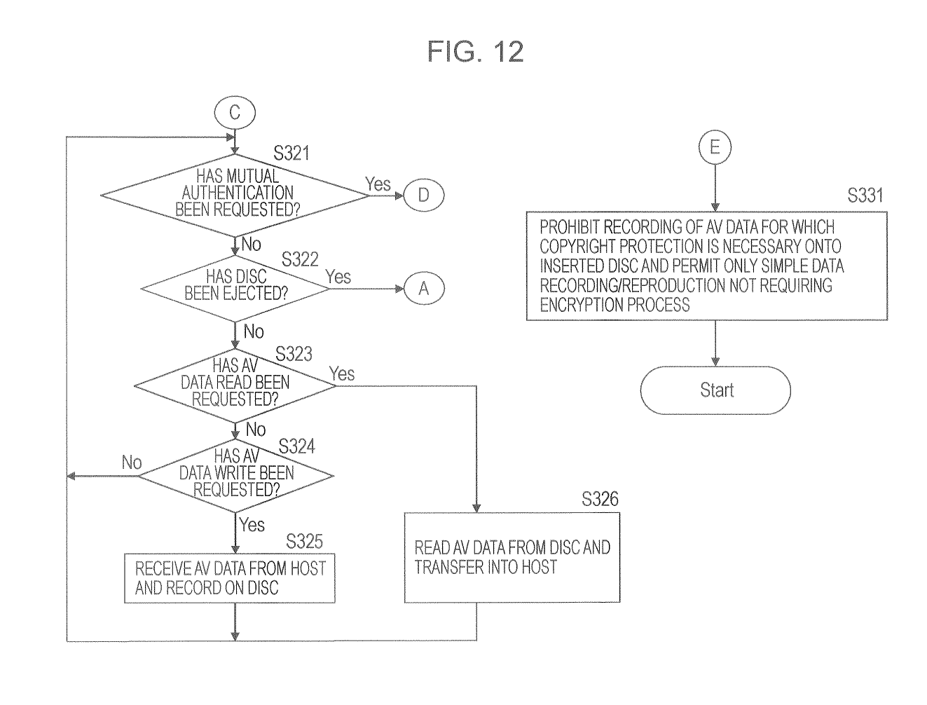

First, processing on the drive side will be described with reference to FIGS. 11 and 12. When the drive detects loading of a medium (disc) in step S301 of FIG. 11, in step S302, the drive reads, from the medium (disc), an RKB that is stored as an encrypted key block such that a media key (Km) is set as encrypted data.

When it is determined in step S303 that the reading of the RKB has failed, the process proceeds to [E] shown in FIG. 12. In step S331, the recording of AV data (content) requiring copyright protection using an inserted medium is prohibited, and only recording/reproduction of data not requiring an encryption process, for which copyright is not protected, is permitted.

When it is determined in step S303 that the reading of the RKB has succeeded, in step S304, a process for an RKB using the device key (Kdev) stored in the drive is performed. When the RKB process has failed and the media key (Km) could not be obtained, the drive is determined to have been revoked (step S305: Yes), and the process proceeds to step S331 of [E] in FIG. 12, where only a recording/reproduction process of only content that is not data for which copyright should be protected is permitted.

When the process for the RKB has succeeded, the drive is determined to have not been revoked (step S305: No), and in step S306, the media key (Km) is obtained from the RKB. Next, in step S307, a BCA recode from the BCA of the medium is read. In step S308, a process for verifying BCA slot data is performed.

When reading of the media ID has failed (S309: No), the process proceeds to step S331 of [E] in FIG. 12, where only a process for recording or reproducing only content for which copyright need not be protected is permitted.

When the reading of the media ID has succeeded (S309: Yes), the process proceeds to step S310, where waiting for a mutual authentication process request from the host is done. When a mutual authentication processing request from the host occurs in step S311, the mutual authentication and key exchange (AKE) process between the host and the drive (see FIG. 7) is performed to share a session key (Ks) between the host and the drive. When the completion of the mutual authentication and key exchange (AKE) process is confirmed in step S312, and waiting for a key information transfer request from the host is done and a key information transfer request occurs from the host in step S313, in step S314, a media ID encrypted using the session key (Ks), that is, [EKs (ID disc)] and a disc key encrypted using the session key (Ks), that is, [EKs(Kd)] are generated and transferred to the host.

When the completion of the transfer of the key information is confirmed in step S315, the process proceeds to step 321 of FIG. 12. In step S321, waiting for a new mutual authentication request is done. When a new mutual authentication request occurs, the process returns to [D], that is, step S311, and mutual authentication and subsequent processing is performed. This process is a process that occurs when the application is switched on the host side.

In step S322, a determination is made whether the disc has been ejected. When the disc has been ejected, the process returns to the initial state [A], that is, step S301. In step S323, a determination is made whether a request for reading content (AV data) occurs from the host. When a request for reading content (AV data) occurs from the host in step S326, content is read from the medium and is transferred to the host. During this processing, seed information used to generate a block key that is directly used for a content decryption process is read from the medium in response to a reading request from the host, which is made as appropriate, and is transferred to the host.

Furthermore, in step S324 it is determined whether or not a request for writing content (AV data) from the host has occurred. When a request for writing content (AV data) from the host has occurred in step S3253, a process for inputting the content (AV data) from the host and for writing the input content onto a medium is performed During this processing a process for also inputting a random number used to generate a block key used for the content encryption process at an appropriate time and for writing this as seed information onto a medium is performed.

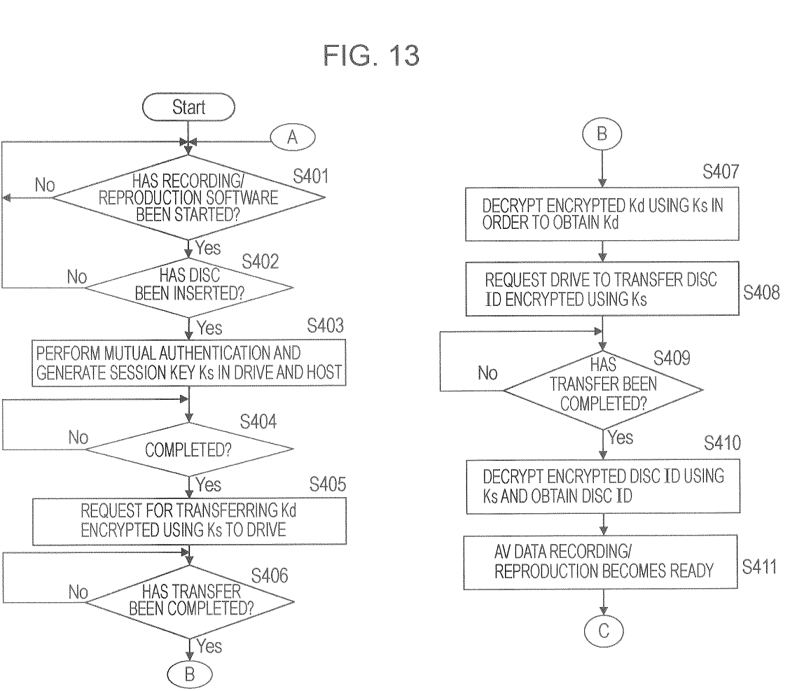

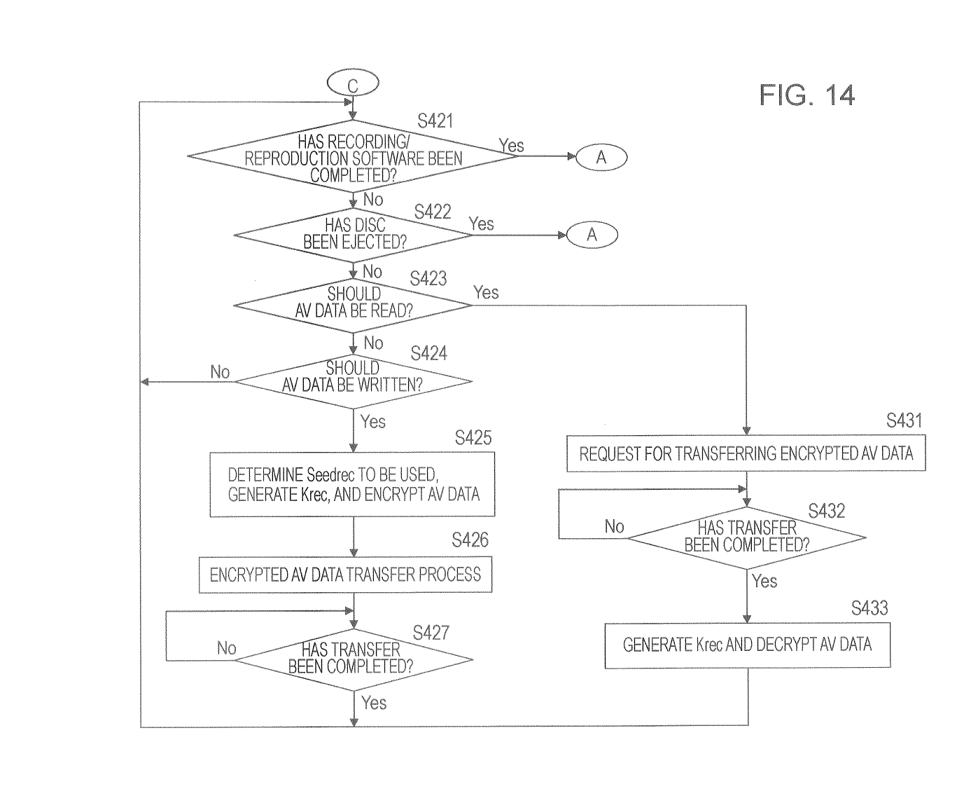

Next, a description will be given of processing on the host side with reference to FIGS. 13 and 14. In step S401, a content reproduction or recording application program is started. In step S402, a report that a disc has been inserted into the drive is received. Then, in step S403, processing for performing mutual authentication with the drive and for sharing a session key with the drive is performed.

When the completion of the mutual authentication and key exchange (AKE) process is confirmed in step S404, the process proceeds to step S405, where the host requests the drive to transfer the disc key (Kd) encrypted using the session key (Ks).

When the reception of the encrypted disc key [EKs(Kd)] from the drive is confirmed in step S406, in step S407, the encrypted disc key [EKs(Kd)] is decrypted using the session key Ks in order to obtain a disc key (Kd).

Furthermore, in step S408, the host requests the drive to transfer the media ID (IDdisc) encrypted using the session key (Ks). When the reception of the encrypted media ID [EKs (IDdisc)] from the drive is confirmed in step S409, in step S410, the encrypted media ID [EKs (IDdisc)] is decrypted using the session key Ks in order to obtain a media ID (IDdisc).

In step S411, the host becomes ready for recording and reproducing content and can notify the user of the fact that content recording/reproduction is ready via a user interface such as a screen display.

Next, after it is confirmed that the recording or reproduction software has not been completed (S421) and that the disc has not been ejected (S422), when it is determined that content should be read in accordance with user instructions or the like (S423: Yes), a request for transferring encrypted content (AV data) is output to the drive in step S431.

When the completion of the reception of the content from the drive is confirmed (S432: Yes) in step S432, in step S433, a recording key (Krec) is calculated on the basis of the seed information (Seedrec), the disc key (Kd), and the media ID (IDdisc) recorded on the disc, which are obtained at an appropriate time from the drive, so that content can be reproduced by decrypting encrypted content received from the drive by using the recording key (Krec). As described above, when the recording key (Krec) is to be calculated, the seed information different for each piece of content in predetermined units by using the seed information in predetermined content units is generated and recorded on the medium at the same time as when the content is recorded.

On the other hand, when it is determined in step S424 that the content should be written in accordance with user instructions or the like (S424 Yes), the process proceeds to step S425, where the host performs a content encryption process by using the recording key (Krec) generated by using the seed information (Seedrec) obtained by generating a random number at an appropriate time, the disc key (Kd) received from the drive, and the media ID (IDdisc). As described above, in the content encryption process, a random number is generated, a block key serving as an encryption key in units of blocks is generated by using the generated random number, and an encryption process in units of blocks is performed using the generated block key.

The host performs a process for transferring (outputting) the generated encrypted data to the drive in step S426, and confirms the completion of the transfer in step S427. The processing is then completed.

[3. Configuration of the Information Processing Apparatus]

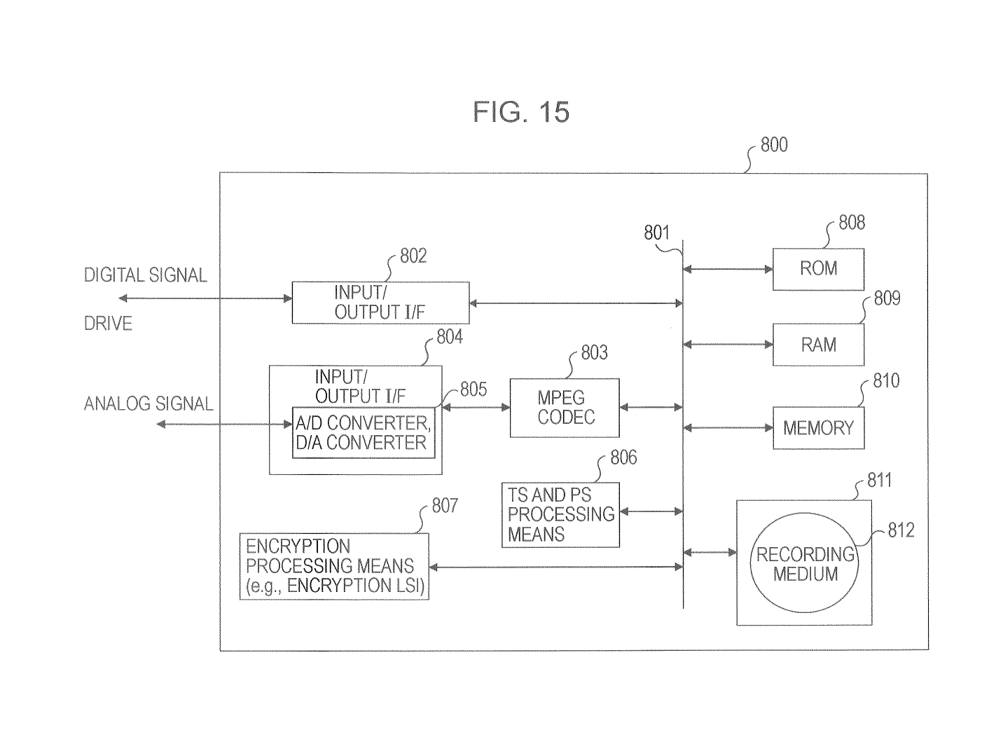

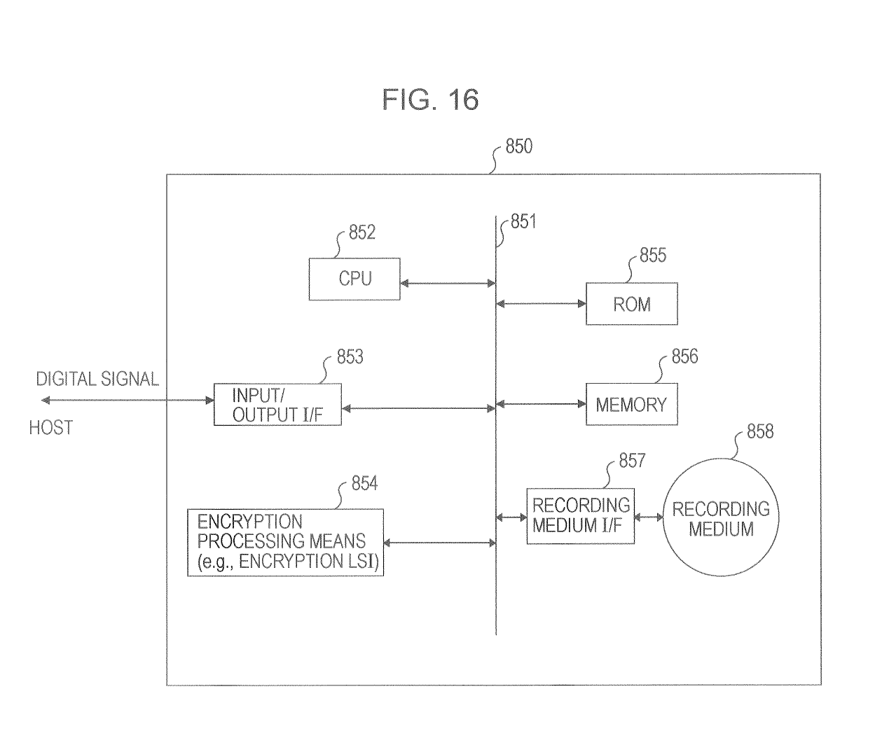

Next, a description will be given, with reference to FIGS. 15 and 16, of examples of the configuration of the information processing apparatuses as the host and the drive.

A description will be given first, with reference to FIG. 15, of an example of the configuration of the information processing apparatus serving as a host. An information processing apparatus 800 includes a CPU 809 for performing data processing in accordance with various programs, such as an OS, a content reproduction or recording application program, and a mutual authentication program; a ROM 808 as storage area for programs, parameters and the like; a memory 810; an input/output T/F 802 for inputting and outputting a digital signal; an input/output I/F 804 for inputting and outputting an analog signal, the input/output I/F 804 having A/D and D/A converters 805; an MPEG codec 803 for encoding and decoding MPEG data; TSPS processing means 806 for performing TS (Transport Stream) and PS (Program Stream) processes; encryption processing means 807 for performing various encryption processes, such as mutual authentication and an encrypted content decryption process; a recording medium 812 such as a hard disk; and a drive 811 for driving the recording medium 812 and for inputting and outputting a data recording/reproduction signal. Each of the blocks is connected to the bus 801.

The information processing apparatus (host) 800 is connected to the drive via, for example, a connection bus, such as an ATAPI-bus Secret information, such as the media ID and the disc key, encrypted using the above-described session key, content to be transferred, or the like are input and output via the input/output I/F 802 for digital signals. The encryption process and the decryption process are performed by the encryption processing means 807 by using, for example, a triple DES algorithm, an AES algorithm, or the like.

A program for executing a content reproduction or recording process is stored in, for example, the ROM 808. While the program is being executed the memory 810 is used to store parameters and data and used as a work area as necessary.

In the ROM 808 or the recording medium 812, the public key of the management center, a secret key corresponding to the host, a public key certificate corresponding to the host, and a revocation list are stored.

Next, a description will be given, with reference to FIG. 16, of an information processing apparatus serving as a drive for reading content stored on an information recording medium and for recording content thereon, and for transferring data to a host. A drive 850 includes a CPU 852 for performing data processing in accordance with various programs such as a program for reading, recording, and transferring content, and a mutual authentication program; a ROM 855 and a memory 856 serving as storage areas for programs, parameters and the like; an input/output I/F 853 for inputting and outputting a digital signal; encryption processing means 854 for performing encryption processing, such as mutual authentication and an output data encryption process; and a recording medium I/F 857 for driving an information recording medium 858 such as a DVD or a Blu-ray disc and for inputting and outputting a data recording/reproduction signal. Each of the blocks is connected to a bus 851.

The drive 850 is connected to the host via, for example, a connection bus such as an ATAPI-bus. For example, secret information such as the media ID and the disc key, encrypted content stored on the information recording medium 858, encrypted content to be recorded on the information recording medium 858, and the like are input and output via the input/output I/F 853 set as a data transferring interface with an external device. The encryption process and the decryption process are performed by the encryption processing means 854 by using, for example, a triple DES algorithm or an AES algorithm.

In the ROM 855 and the memory 856, the following are stored: the public key of the management center, the secret key corresponding to the drive, the public key certificate corresponding to the drive, the device key: Kdev used for processing the encrypted key block RKB, and verification information serving as a header code corresponding to the media ID (the verification data 202 shown in FIG. 6). Furthermore, a program for reading and obtaining content, and a pro-ram for executing a mutual authentication process, and the like are stored.

In the foregoing the present invention has been described in detail while referring to specific embodiments. However, it is self-explanatory that a person skilled in the art can make modifications and alterations of the embodiments within the scope and spirit of the present invention. That is, the present invention has been described in the form of examples and should not be construed as being limited. To determine the gist of the present invention, the claims should be taken into consideration.

The series of processes described in the specification can be performed by hardware, software, or the combined configuration of them. When the series of processes is to be performed by software, a program in which a processing sequence is recorded is installed in a memory in a computer that is incorporated in specialized hardware, whereby it is performed, or the program is installed into a general-purpose computer that is capable of performing various processes, whereby it is performed.

For example, the program can be recorded in advance in a hard disk and a ROM (Read Only Memory) serving as recording media. Alternatively, the program can be temporarily or permanently stored (recorded) on a removable recording medium, such as a flexible disk, a CD-ROM (Compact Disc Read Only Memory), an MO (Magneto optical) disc, a DVD (Digital Versatile Disc), a magnetic disc, or a semiconductor memory. Such a removable recording medium can be provided as packaged software.

In addition to being installed into a computer from the removable recording medium such as that described above, the program may be transferred wirelessly from a download site or may be transferred by wire to a computer via a network, such as a LAN (Local Area Network) or the Internet, and it is possible for the computer to receive the program that is transferred in such a manner and to install the program into the hard disk contained therein.

Various processes described in the specification may be executed not only in a time-series manner according to the written orders, but may also be executed concurrently or individually according to the processing performance of the apparatus that performs processing or as necessary. In this specification the system designates a logical assembly of a plurality of devices. It is not essential that the devices be disposed in the same housing.

### INDUSTRIAL APPLICABILITY

As has thus been described, according to the configuration of the present invention, in a content reproduction or recording process involving data transfer between two different devices such as a drive and a host, it is possible to prevent outside leakage of a media ID (disc ID) used for a content encryption or decryption process performed when content is to be recorded or reproduced.

According to the configuration of the present invention, the drive reads a media ID (disc ID) from a medium, and verifies whether this has been recorded in such a manner as to correspond to a header code set on a correct valid medium. Furthermore, when it is confirmed by the verification that the medium is a valid medium, the drive encrypts the media ID and outputs it to the host. Therefore, it becomes possible to decrease the possibility that the media ID is leaked externally. Furthermore, since a content reproduction or recording process is permitted under the condition that the medium is confirmed to be a valid medium it is possible to prevent a content reproduction or recording process using an invalid medium.

1. An information processing apparatus comprising:
a recording medium interface for performing input and output of data to be written onto an information recording medium or data to be read from an information recording medium;
a data transferring interface for performing input and output of transfer data from and to an external device;
a storage section in which verification data for confirming the validity of the information recording medium is stored; and
a data processor for reading code recorded on the information recording medium as information corresponding to a media identifier of the information recording medium, for confirming the validity of the information recording medium by verifying the code against the verification data, and for encrypting and externally outputting the media identifier under the condition that the validity has been confirmed.

2. The information processing apparatus according to claim 1, wherein the data processor performs an authentication process for the external device that inputs and outputs data via the data transferring interface and outputs the media identifier to the external device under the condition that the result of the authentication process is positive.

3. The information processing apparatus according to claim 2, wherein the data processor encrypts the media identifier by using a session key generated in the authentication process and outputs the media identifier as encrypted data on the basis of the session key to the external device.

4. The information processing apparatus according to claim 1, wherein the storage section stores code information set in such a manner as to correspond to the identifier of the information recording medium that is legally manufactured under a license, and
the data processor reads code recorded on the information recording medium as information corresponding to the media identifier of the information recording medium, confirms the validity of the information recording medium by verifying the code against the code stored as the verification data, and encrypts and externally outputs the media identifier under the condition that the validity has been confirmed.

5. The information processing apparatus according to claim 1, wherein the data processor reads code as information corresponding to the media identifier recorded in a BCA (burst cutting area) of the information recording medium and verifies the code against the verification data.

6. The information processing apparatus according to claim 1, wherein the data processor inputs encrypted data on the basis of an encryption key generated by using the media identifier from the external device via the data transferring interface, and
writes the input data onto an information recording medium.

7. The information processing apparatus according to claim 1, wherein the data processor reads, from the information recording medium, encrypted data on the basis of an encryption key generated by using the media identifier, and
outputs the read data to the external device via the data transferring interface.

8. An information processing method comprising:
a code reading step of reading code recorded on an information recording medium as information corresponding to a media identifier of the information recording medium;
a validity confirmation step of confirming the validity of the information recording medium by verifying the code against verification data stored in a storage section; and
a media identifier output step of encrypting and externally outputting the media identifier under the condition that the validity of the information recording medium has been confirmed in the validity confirmation step.

9. The information processing method according to claim 8, further comprising an authentication performing step of performing an authentication process with an external device that inputs and outputs data via the data transferring interface, wherein a process for outputting the media identifier to the external device is performed under the condition that the result of the authentication process is positive.

10. The information processing method according to claim 9, wherein the media identifier output step is a step of encrypting the media identifier by using a session key generated in the authentication process and outputting the media identifier as encrypted data on the basis of the session key to the external device.

11. The information processing method according to claim 8 wherein the validity confirmation step is a step of reading code recorded on the information recording medium as information corresponding to a media identifier of the information recording medium and confirming the validity of the information recording medium by verifying the code against code that is set in such a manner as to correspond to an identifier of the information recording medium that is legally manufactured under a license stored in a storage section.

12. The information processing method according to claim 8, wherein the code reading step is a step of reading code as information corresponding to the media identifier recorded in a BCA (burst cutting area) of the information recording medium.

13. The information processing method according to claim 8, further comprising a step of inputting encrypted data on the basis of an encryption key generated by using the media identifier from an external device via the data transferring interface; and
a step of writing the input data onto the information recording medium.

14. The information processing method according to claim 8, further comprising a step of reading, from the information recording medium, the encrypted data on the basis of an encryption key generated by using the media identifier; and
a step of outputting the read data to the external device via the data transferring interface.

15. A computer program that performs access control for an information recording medium, the computer program comprising:
a code reading step of reading code recorded on an information recording medium as information corresponding to a media identifier of the information recording medium;
a validity confirmation step of confirming the validity of the information recording medium by verifying the code against verification data stored in a storage section; and
a media identifier output step of encrypting and externally outputting the media identifier under the condition that the validity of the information recording medium has been confirmed in the validity confirmation step.
